(19) United States
(12) Patent Application Publication
(10) Pub. No.: US 2010/0169007 A1
(43) Pub. Date: Jul. 1, 2010

(54) Method and apparatus for navigation system for detecting and warning traffic rule violation

(76) Inventors: Shashikumar Kaushik, Torrance, CA (US); Ashish Patel, Torrance, CA (US)

Correspondence Address: MURAMATSU & ASSOCIATES;Suite 310, 114 Pacifica, Irvine, CA, 92618, US

(21) Appl. No.: 12/317,816

(22) Filed: Dec. 30, 2008

(51) Int. Cl. G01C 21/26

(52) U.S. Cl. 701/208; 701/207

(57) ABSTRACT

A method and apparatus for a navigation system is designed to avoid traffic rule violation. The method includes the steps of: evaluating requirements prescribed by local carpool lane regulation for using a carpool lane of a road; determining a number of occupants of a vehicle; determining whether the number of occupants of the vehicle satisfies the requirements; detecting a current location of the vehicle as to which lane the vehicle is running; detecting a lane change action for the carpool lane indicating that the vehicle enters the carpool lane or about to enter the carpool lane; and generating a warning for notifying violation of carpool lane regulation when the lane change action for the carpool lane is detected and the number of occupants fails to satisfy the requirements.

### FIELD OF THE INVENTION

This invention relates generally to a method and apparatus incorporated in a navigation system for avoiding traffic rule violation, and more particularly, to a method and apparatus for avoiding the violation of high occupancy lane rule for a navigation system which generates a warning message based on a detected number of occupants and detected entry into a high occupancy vehicle lane.

### BACKGROUND OF THE INVENTION

A navigation system (global positioning system or GPS) performs travel guidance for enabling a user to easily and quickly reach the selected destination. A typical example is a vehicle navigation system which guides a driver of a vehicle to a destination through a calculated route. Such a navigation system detects the position of the user's vehicle, and reads out map data pertaining to an area at the current vehicle position from a data storage medium, for example, a CD-ROM (compact disc read-only memory), a DVD (digital versatile disc), or a hard disc. Typically, the navigation system displays a map image on a monitor screen while superimposing thereon a mark representing the current location of the user.

FIGS. 1A-1H show an example of overall procedure and screen display involved in the navigation system for route guidance to a destination. FIG. 1A shows an example of locator map screen of the navigation system when the destination is not specified. Typically, the navigation system displays a street on which the vehicle (current vehicle position VP) is running on a map image and a name of the street. Other information such as a north pointer NP, a map scale and a current time may also be illustrated on the display screen.

When a user selects to set a destination, the navigation system displays a “Find Destination by” screen as shown in FIG. 1B for specifying an input method for selecting the destination. When selecting, the “Point of Interest” method in FIG. 1B, the navigation system displays selection methods of point of interest (POI) either by “Place Name” or “Place Type” in FIG. 1C. If the “Place Type” is selected, the navigation system lists categories of POIs as shown in FIG. 1D.

FIG. 1E shows a screen when the user has selected a “Restaurant” category in FIG. 1D, which includes a list of names of POI type “Restaurant” typically sorted by distance from the current position. The user selects a desired destination, as shown in FIG. 1F and presses an “OK to Proceed” button for the navigation system to calculate an appropriate route to the destination. FIG. 1G shows an example of screen when the navigation system calculates and determines the route to the destination. After determining the route, the navigation system starts the route guidance to the destination as shown in FIG. 1H.

In the operation of the navigation system noted above, typically, the navigation system is able to calculate a route from a starting point to a destination and guide the user to the destination. During such a trip to the destination, either in the route guidance mode or not, a user prefers to use a “high-occupancy vehicle lane” or so called a “carpool lane” because it has less traffic. Typically, a high-occupancy vehicle lane is a lane reserved for vehicles with two or more occupants.

The violation of rule regarding the high-occupancy vehicle lane can subject the driver to fines and citation. Because of the recent improvement of the accuracy of GPS system and other technology, such as a video camera and a radar that detect objects surrounding the vehicle, have enabled accurate determination of the vehicle's position. Thus, it is desired that such technology be used to avoid the high-occupancy vehicle lane violation.

### SUMMARY OF THE INVENTION

It is, therefore, an object of the present invention to provide a method and apparatus for a navigation system for detecting an actual or anticipated violation of traffic regulation and issuing a warning to notify the user about the violation.

It is another object of the present invention to provide a method and apparatus for avoiding the violation of high occupancy vehicle lane (carpool lane) rule for a navigation system which generates a warning message based on a detected number of occupants and detected entry into a high occupancy vehicle lane.

It is a further object of the present invention to provide a method and apparatus for a navigation system for detecting an actual or anticipated violation of traffic regulation based on signals from various sensors mounted on a vehicle and issuing a warning to notify the user about the violation.

One aspect of the present invention is a method of avoiding violation of carpool lane regulation for a navigation system. The method includes the steps of: evaluating requirements prescribed by local carpool lane regulation for using a carpool lane of a road; determining a number of occupants of a vehicle with respect to using the carpool lane; determining whether the number of occupants of the vehicle satisfies the requirements for using the carpool lane; detecting a current location of the vehicle as to which lane the vehicle is running; detecting a lane change action for the carpool lane indicating that the vehicle enters the carpool lane or about to enter the carpool lane; and generating a warning for notifying violation of carpool lane regulation when the lane change action for the carpool lane is detected and the number of occupants fails to satisfy the requirements.

In the method of the present invention, the step of evaluating requirements for using the carpool lane includes a step of creating a data table listing the requirements based on map data retrieved from a map database of the navigation system or updated rules searched and retrieved from a remote service provider. The requirements for using the carpool lane include a required number of occupants per vehicle so that only a vehicle having a number of occupants equal to or greater than the required number is allowed to use the carpool lane.

In the method of the present invention, the requirements for using the carpool lane include a required number of occupants per vehicle so that only a vehicle having a number of occupants equal to or greater than the required number is allowed to use the carpool lane, and a specific type of vehicle so that only a vehicle of the specified type is allowed to use the carpool lane even though the required number of occupants is not satisfied.

The method or the present invention further includes a step of determining whether a particular location on the road for entering the carpool lane from a normal lane or for leaving the carpool lane to enter a normal lane made by the vehicle violates traffic regulation. The method further includes a step of generating a warning for notifying violation of the traffic regulation when the particular location on the road for entering the carpool lane or leaving the carpool lane made by the vehicle is illegal.

In the method of the present invention, the step of determining the number of occupants of the vehicle includes a step of evaluating signals from seat sensors or seatbelt sensors mounted on the vehicle thereby determining the number of occupants in the vehicle. The method further includes a step of evaluating an inner image of the vehicle produced by an image sensor for determining the number of occupants in the vehicle or a step of prompting a user to inputs the number of occupants in the navigation system.

In the method of the present invention, the step of detecting the current location of the vehicle as to which lane the vehicle is running includes a step of evaluating image data retrieved from an image sensor in combination with map data of the navigation system which provide data showing a number of lanes, a size of the lane, and a location of the carpool lane.

In the method of the present invention, the step of detecting the lane change action for the carpool lane includes a step of evaluating image data retrieved from an image sensor and a signal indicating a degree or rotation of a vehicle driving wheel from a wheel sensor in combination with map data of the navigation system which provide data showing a number of lanes, a size of the lane, and a location of the carpool lane.

Another aspect of the present invention is an apparatus for a navigation system for detecting an actual or anticipated violation of traffic regulation regarding requirements of using a carpool lane and issuing a warning to notify the user about the violation by implementing the various steps of the display method described above. The apparatus of the present invention detects a number of occupants in the vehicle, a position of the vehicle on the road, any change of lane on the road, etc., and determines if there is any violation of the carpool lane requirements. The apparatus of the present invention generates a warning if there is a possible or actual violation in various manners including a text form, voice sound, etc.

According to the present invention, the navigation system is able to detect the current situation of a vehicle as to whether there is any actual or anticipated violation of a particular traffic regulation. The present invention is advantageously implemented when such a traffic regulation is directed to the requirements of using a high occupancy vehicle lane (carpool lane). The apparatus of the present invention detects a number of occupants in the vehicle, a position of the vehicle on the road, any change of lane on the road, etc., and determines if there is any violation of the carpool lane requirements. To do this, a plurality of sensors are provided inside and outside of a vehicle to detect the conditions concerning the vehicle with respect to the requirements of the traffic regulation. If the vehicle situation is in the traffic rule violation or about to become the traffic rule violation, the method and apparatus of the present invention issue an alert or warning to notify the driver about the traffic rule violation, thereby avoiding the violation.

### BRIEF DESCRIPTION OF THE DRAWINGS

FIGS. 1A-1H are schematic diagrams showing an example of operational process and screen display involved in the navigation system for selecting a destination, determining a calculated route to the destination, and conducting a route guidance operation to the destination.

FIGS. 2A-2D are schematic diagrams showing the situations of lane change related to a carpool lane where FIG. 2A shows a lane change that does not involve entry into the carpool lane, FIG. 2B shows a lane change involving entry into a carpool lane, FIG. 2C shows a lane change at a location where the lane change for the carpool lane is prohibited, and FIG. 2D shows a lane change from the carpool lane to the normal lane.

FIG. 3 is a schematic diagram showing an example of screen display of a navigation system in the present invention that generates a warning message when the regulation on the carpool lane is violated.

FIGS. 4A and 4B are diagrams showing examples of sensors mounted on a vehicle for implementing the present invention where FIG. 4A shows an example of locations of the sensors on the vehicle and FIG. 4B shows a block diagram of a controller and different types of sensors.

FIG. 5 is a plan view showing an example of arrangement of sensors installed on a vehicle for use with the navigation system of the present invention and a coverage scope of each sensor provided on the vehicle.

FIG. 6 is a plan view showing another example of arrangement of sensors installed on a vehicle for use with the navigation system of the present invention and a coverage scope of each sensor provided on the vehicle.

FIG. 7 is a plan view showing an example of sensor scopes and range allocations of sensors provided on the vehicle to perceive conditions surrounding the vehicle in the present invention.

FIG. 8 is a flow chart showing an example of operational steps of the present invention for detecting the violation of the regulation of carpool lane and issuing a warning notifying the violation.

FIG. 9 is a flow chart showing another example of operational steps of the present invention for detecting the violation of the regulation of carpool lane and issuing a warning notifying the violation.

FIG. 10 is a flow chart showing an example of operational steps of the present invention for determining the number of occupants in the vehicle.

FIG. 11 is a diagram showing an example of data representing the requirements of using a carpool lane and data representing the current situation of the vehicle, which are used to determine if the requisite condition for driving the carpool lane is met.

FIG. 12 is a functional block diagram of a vehicle navigation system implementing the method of the present invention for detecting a situation of traffic violation regarding the carpool lane.

### DETAILED DESCRIPTION OF THE PREFERRED EMBODIMENT

The method and apparatus of the present invention for a navigation system is described in detail with reference to the accompanying drawings. The method and apparatus detects the traffic rule violation concerning the high occupancy vehicle lane and issues an alert or warning notifying the violation. The method and apparatus of the present invention is designed to detect the current situation of a vehicle as to whether there is any actual or anticipated violation of a particular traffic regulation. If the vehicle situation is in the traffic rule violation or about to become the traffic rule violation, the method and apparatus of the present invention issue an alert or warning to notify the driver about the violation.

In a typical freeway or expressway, there is a lane referred to as a high-occupancy vehicle lane or a carpool lane in which only vehicles having two or more passengers can travel. In some states, such a carpool lane is also open to a special type of vehicles such as hybrid engine vehicles or fuel cell vehicles, etc. that are considered as clean-air vehicles. If a vehicle which is not qualified to use the carpool lane travels in the carpool lane, the driver may be subjected to citation and fines.

To avoid such a violation of traffic regulation concerning the carpool lane (high-occupancy vehicle lane), a plurality of sensors are provided inside and outside of a vehicle to detect the conditions concerning the vehicle with respect to the requirements of the traffic regulation. Typically, the map data of the navigation system provides the requirements of using a particular carpool lane in a particular state, etc., which can be retrieved and evaluated for implementing the present invention. The method and apparatus of the present invention will determine the number of occupants in the vehicle. When the vehicle enters or attempts to enter into the carpool lane that requires the number of occupants that exceeds the number of occupants in the vehicle, the navigation system issues a warning.

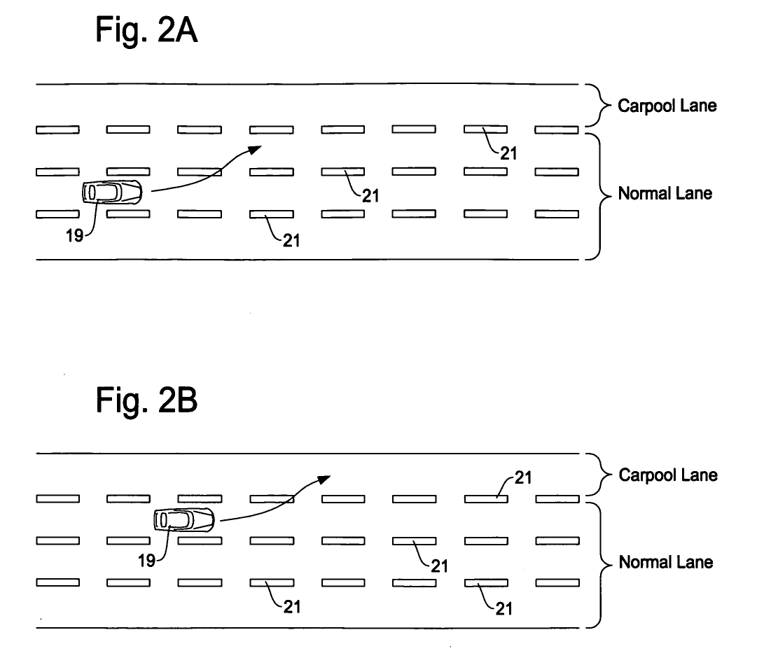

FIGS. 2A to 2D are schematic diagrams showing a vehicle 19 on a freeway (express way) to describe the situation where the present invention would be implemented for detecting the carpool lane violation and generating the warning message regarding the violation. In those examples, four lanes, three of which are normal lanes and one is a carpool lane, are shown where each lane is separated by lane separators 21. In many states, the carpool lane requires at least two (2) occupants in the vehicle.

FIG. 2A shows the case where the vehicle 19 on one of the normal lanes attempts to make a lane change in the direction shown by the arrow in front of the vehicle 19. In this case, the next lane in the left to which the vehicle 19 attempts to move is a normal lane rather than a carpool lane. Thus, since there is not violation of carpool lane regulation, the alert regarding the violation will not be triggered by the navigation system.

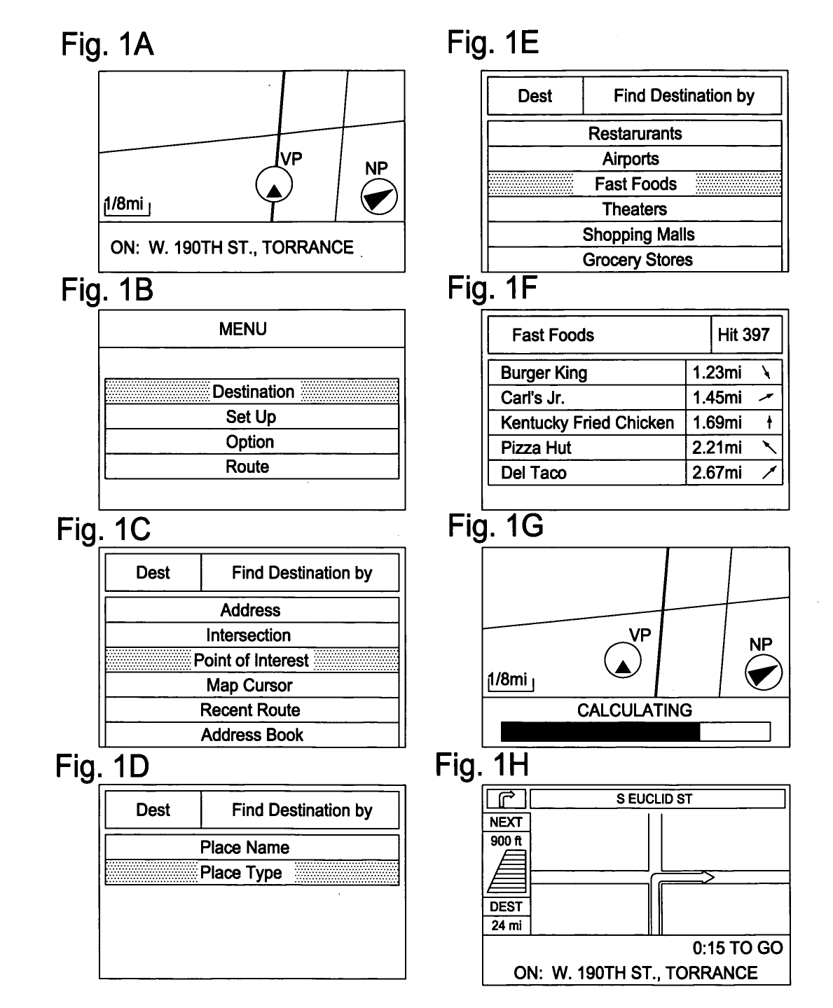

FIG. 2B is similar to FIG. 1A but the vehicle 19 attempts to move to the carpool lane from the normal lane as indicated by the arrow. If the number of occupants of the vehicle 19 does not satisfy the minimum number of occupants prescribed by the traffic regulation, this results in the traffic violation. Thus, the navigation system of the present invention will issue a warning to notify the driver about the traffic violation.

FIG. 2C shows a situation where the vehicle 19 is about to violate the traffic regulation by entering into the carpool lane at a prohibited point. Typically, the carpool lane is separated by the normal lanes by a solid long line as indicated by a lane separator 21A or double lines, etc. Entering into the carpool lane from the normal lane or leaving the carpool lane for the normal lane is prohibited at the location of the lane separator 21A.

Such a lane change has to be made at the predetermined location where the carpool lane and the normal lane are separated by the short lane separator 21 rather than the solid long separator 21A. Thus, even the number of occupants of the vehicle is two or more, it would be a traffic violation if the vehicle changes to the carpool lane in the manner shown in FIG. 2C. By detecting the attempts of the driver to enter the carpool lane, the navigation system of the present invention will issue a warning to notify the driver about the traffic violation.

FIG. 2D shows a situation where the vehicle 19 is about to change the lane from the carpool lane to the normal lane at the location of short lane separators 21. Namely, after passing the location where the solid long lane separator 21A, the driver attempts to enter the normal lane from the carpool lane, which is allowable. Thus, when detecting the attempts of the driver to leave the carpool lane, the navigation system of the present invention will not issue a warning since this activity does not constitute the violation of traffic regulation.

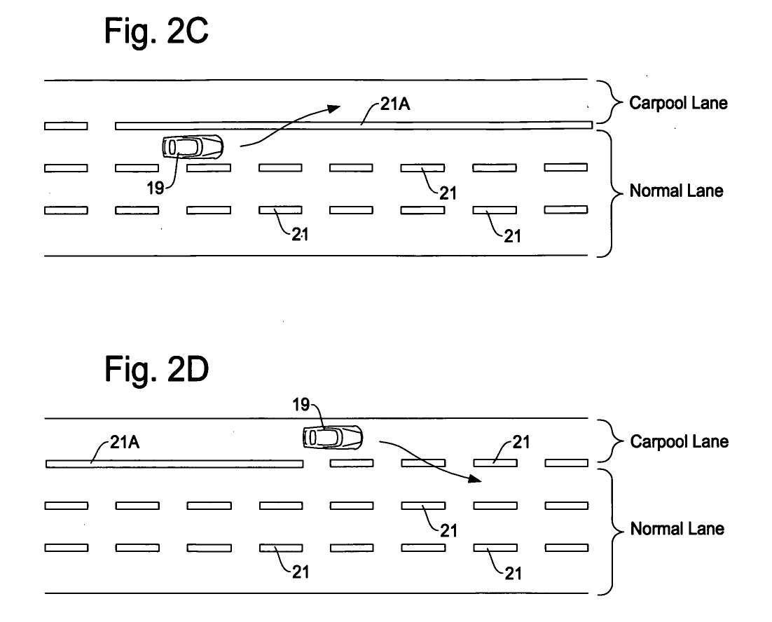

FIG. 3 is a schematic diagram showing an example of screen display of a navigation system in the present invention that generates a warning message when the high occupancy vehicle lane rule is violated. The warning is generated when the user enters or attempts to enter into the high occupancy vehicle lane (carpool lane) when the number of occupants falls short of the minimum required number to drive the carpool lane. The navigation system not only displays the warning message in the text form as shown in FIG. 3 but also may issue the warning by sound alarm or voice message informing about the violation of the traffic regulation.

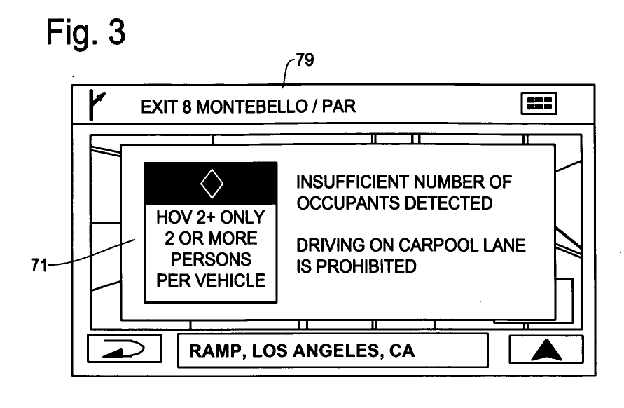

FIGS. 4A and 4B are diagrams showing examples of sensors installed in a vehicle for implementing the present invention where FIG. 4A shows an example of locations of the sensors on the vehicle and FIG. 4B shows a block diagram of different types of sensors. The example of FIG. 4A shows a video/radar sensor, a wheel sensor, a seat sensor, a seatbelt sensor, and a door sensor.

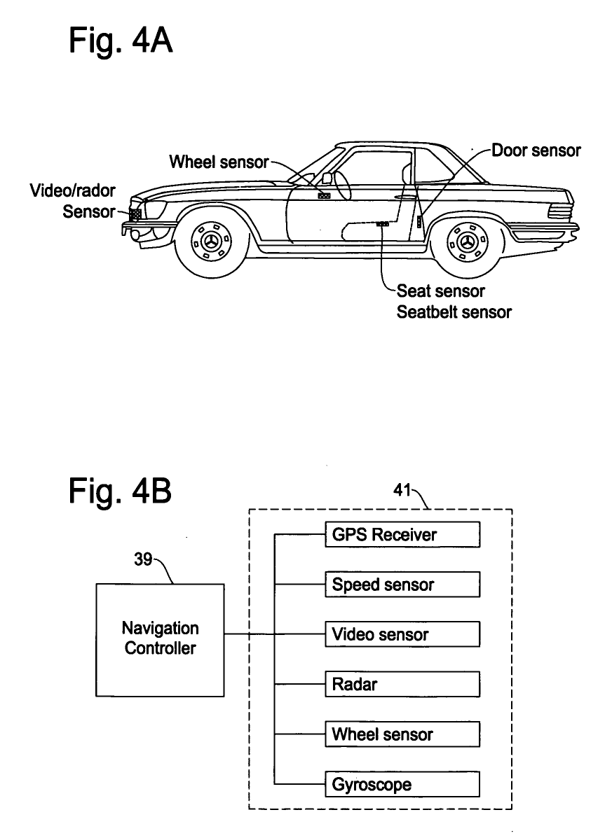

In determining the lane on which the vehicle is running, the lane change of the vehicle, or determining whether this is a carpool lane or not, a radar and/or video sensor (camera) may be utilized. Hereafter, a combination of radar and video sensor may also be referred to as an image sensor. A plurality of image sensors will be provided on the vehicle to detect lane separators, other vehicles, landmarks, etc. Examples of layout of the images sensors and their viewing (detection) ranges and distances are provided in FIGS. 5-7.

The lane separators perceived by the image sensors are evaluated with respect to the road (geographic) data retrieved from a map database of the navigation system. For example, if the road data indicate that a particular freeway has a carpool lane between a particular range, a mechanism to detect long lane separator captured by the image sensors such as cameras in real time can identify the carpool lane. The carpool lane can also be identified based on the image data obtained by cameras because it is usually located at the very left of the freeway. The requirements for using the carpool lane can be found in the map database of the navigation system which may vary from states to states or type of freeway or expressway.

The detected lane separators will be compared with subsequently detected lane separators repeatedly as to whether the detected lane separators are substantially on the same line or not. For example, if the detected lane separator is on the direction of line extended from the previously detected lane separator, the present invention can determine that the vehicle is travelling on the same line. If the detected lane separator is deviated from the direction of the line extended from the previously detected lane separator, the present invention can determine that the vehicle is about to change the lane.

The detection of lane change may also be performed or supplemented by means of a wheel sensor that detects a degree of rotation of the driving wheel by a driver for lane change. Whether there is a change of lane may be a function of the degree of rotation of the driving wheel and the vehicle speed, thus, a vehicle speed sensor may also be used in combination of the wheel sensor. Moreover, the user's operation of a turn signal (blinker), which is generally associated with such a lane change, may also be used to detect the lane change.

A seat sensor of FIG. 4A is to detect the number of occupants in the vehicle so as to determine whether there are two or more occupants in the vehicle to be qualified to use the carpool lane. The seat sensor can be a pressure sensor to detect whether a passenger is using the seat, or a camera to distinguish passengers in the vehicle from other objects such as baggages by analysis of video image. A seatbelt sensor can also be used for counting the number of occupants in the vehicle by checking how many seatbelts are fastened in combination with the seat sensor. The number of occupants can also be input by the user in the navigation system when the engine of the vehicle is started, etc.

FIG. 4B shows a navigation controller 39 of a vehicle navigation system connected to a sensor unit 41 to implement the present invention by detecting information via various sensors. The sensor unit 41 includes a plurality of sensors, such as a GPS receiver, vehicle speed sensor, video sensor (camera), radar, wheel sensor and a gyroscope. The gyroscope detects an angle or direction of the vehicle, which may also be used to detect the lane change. The GPS receiver, vehicle speed sensor, and the gyroscope are used to determine the current position of the vehicle as well as the operation of the lane change.

For instance, as described above, the image sensor (camera and radar) records the image of the lane separators and compares the currently perceived image with the previously perceived image. The image sensor may also compare the currently perceived image with the expected value created based on the map data. A carpool lane is generally located at the leftmost of the freeway and separated by a specific lane separators such as long yellow thicker separator. Such characteristics can be used to determine the lane on which the vehicle is travelling and changing the lane into the carpool lane.

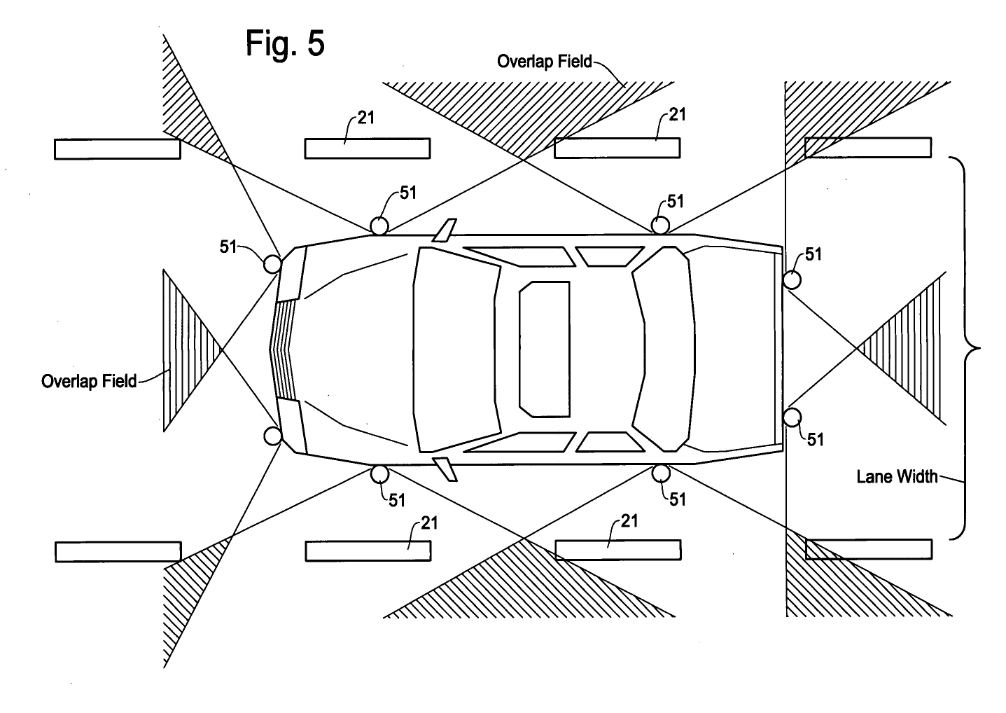

FIGS. 5 and 6 show an example of arrangement of sensors (image sensors) on the vehicle to evaluate the surrounding conditions and images for implementing the present invention. FIG. 5 is a plan view of a vehicle and a road showing a plurality of sensors 51 installed on the vehicle. The lane separators 21 are shown at both sides of the vehicle. In the example of FIG. 5, eight sensors 51 are installed around the vehicle. Each sensor 51 emits radar to find lane separators, marks, other vehicles and measure the distances from the those objects by evaluating the reflected radar beams. Each sensor 51 also includes a camera to acquire an image of the predetermined area that surrounds the vehicle. Overlapped areas created by the plurality of sensors are shown by the hatching in FIG. 5.

FIG. 6 is a plan view showing another example of arrangement of the plurality of sensors 51 installed on the vehicle. The lane separators 21 are shown at both sides of the vehicle. In FIG. 6, six sensors, instead of eight in FIG. 5, are installed around the vehicle. Each sensor unit 51 emits the radar beams and measures the reflected radar beams to find other vehicles and measure the distance between the user's vehicle and other vehicles. Each sensor 51 also includes a camera to acquire an image of the predetermined area that surrounds the vehicle. Overlapping fields created by the plurality of sensors are shadowed by the hatching in FIG. 6.

In this manner, the present invention can be implemented by the sensor arrangement described above with reference to FIGS. 5 and 6 in order to detect the lane on which the vehicle is running and if there is any action of lane change by the vehicle. Also based on the signals from the sensor arrangement, the navigation system determines which lane is the carpool lane as noted above. The sensor arrangement also detects the surrounding objects such as vehicles measure the distances between the user's vehicle and the surrounding vehicles for safe driving.

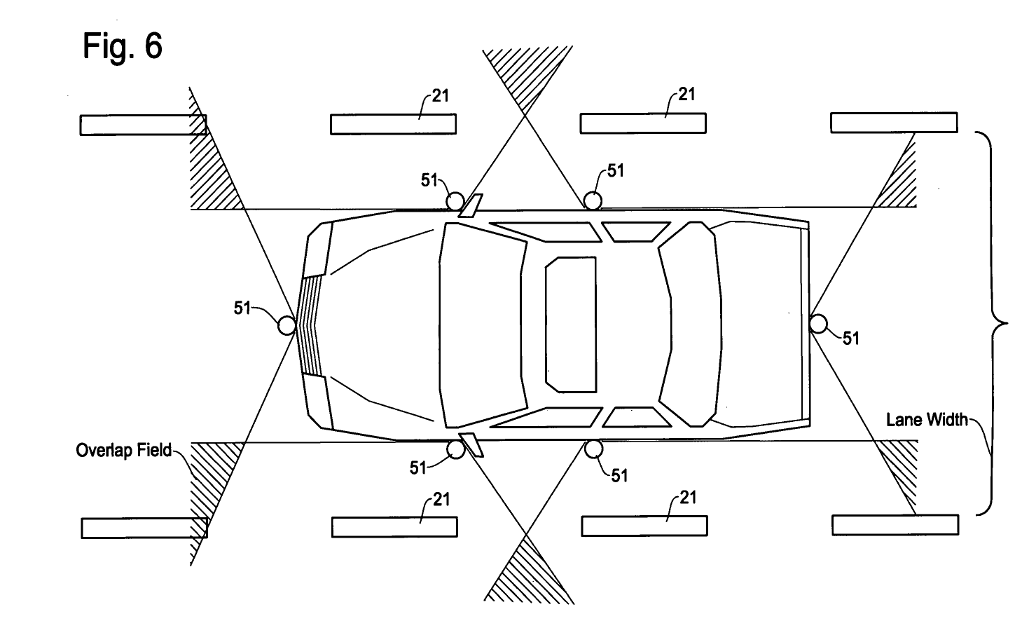

FIG. 7 is a diagram showing the relationship between the location of vehicle, lanes including a carpool lane, and the sensor detection ranges. As shown, the area around the vehicle is monitored by the image sensors, in this example, the image sensors are provided at the front, rear, left and right of the vehicle. The information obtained by the image sensor at the front of the vehicle may play a major role in determining the lane change, which lane is a carpool lane, whether it is a legal location for entrance or exit with respect to the carpool lane, etc. However, accuracy of such determination will be assisted and enhanced by the information from the other image sensors.

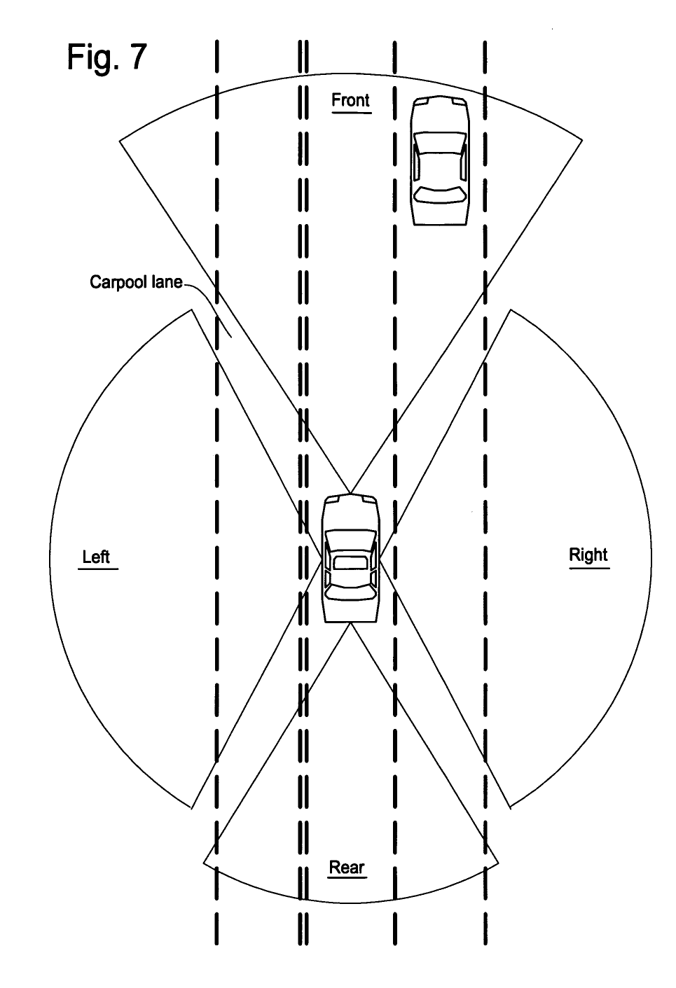

FIG. 8 is a flow chart showing an example of operational process of the present invention for detecting the traffic rule violation concerning the high occupancy vehicle lane and issuing an alert or warning notifying the violation. The process of the present invention detects the current situation of a vehicle as to whether there is any violation of a particular traffic regulation by monitoring the conditions of the vehicle as to number of occupants, lane change to a carpool lane, etc. If the vehicle situation is in traffic rule violation as to the high occupancy vehicle lane (carpool lane) or about to become the traffic rule violation, the process issues an alert or warning to notify the driver about the violation.

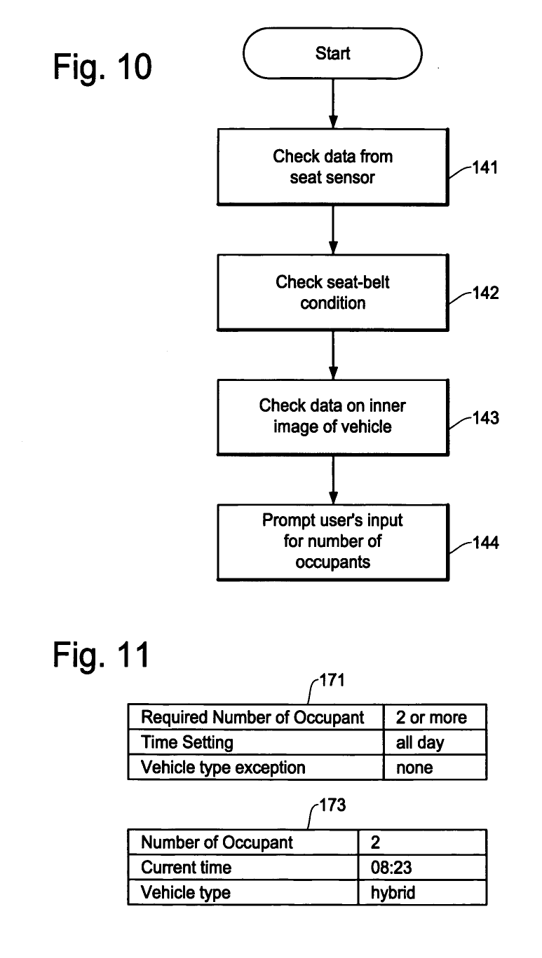

It is assumed that the requirements for using the carpool lane can be found in the map database of the navigation system which may vary from states to states or type of freeway or expressway. Such requirements is retrieved in advance and stored in a memory to easily access the data indicating the requirements as shown by the data table of FIG. 11. As the process starts, the navigation system will determine the number of occupants in the vehicle in the step 101 with respect to the legal requirements for using the carpool lane.

As noted above, the number of occupants may be determined by the signals from the seat sensors, and/or a number of fastened seat belts as will be described in more detail later. The navigation system may also require the user to input the information of the number of occupants at the start of operation. Further, the number of occupants may be determined by processing the data obtained by an image sensor (camera) showing the image of the vehicle inside to distinguish human beings from other objects.

As the number of occupants is determined, the process will check whether the detected number of occupants is two or more in the step 102. This is the case where the local traffic regulation requires at least two occupants in a vehicle to use the carpool lane. Thus, in a state in which the traffic regulation requires the minimum number of three occupants, the step 102 checks whether the detected number of occupants is three or more.

If the number of occupants in the step 102 is less than two, the current condition of the vehicle does not satisfy the legal requirement to use the carpool lane. Thus, the process moves to the step 103 to detect the road lane that the vehicle is running thereon and any change of the road lane toward the carpool lane. As noted above, this step of detecting which lane the vehicle is currently running and if there is any lane change to the carpool lane is conducted based on the data produced by various sensors especially by the image sensor consisting of camera and radar. Further, this step is reinforced by the map data of the navigation system which provides data showing the number of lanes, size of the lane, location of the carpool lane, etc. Moreover, this step is reinforced by the accuracy of position of the vehicle stated by the navigation system.

If the number of occupants in the step 102 is two or more, it means that the current condition of the vehicle satisfies the legal requirements to use the carpool lane, thus, the process moves to the step 106 to check whether a particular location is appropriate for an in/out action with respect to the carpool lane. As shown in FIGS. 2C and 2D, it is illegal to enter or leave the carpool lane at the location where there is a long continuous lane separator 21A while it is legal to enter or leave the carpool lane at the location where there are short lane separators 21. If it is detected that the vehicle changes the lane in an illegal manner, the process issues an warning in the step 107 to notify the violation of traffic regulation.

After the step 103 described above, the process determines whether the vehicle enters or tries to enter the carpool lane in the step 104. As noted above, since the number of occupants in the vehicle is less than two, the vehicle is not qualified to use the carpool lane. Thus, when the action of entry into the carpool lane is detected, the process issues the warning in the step 105 to notify the violation of traffic regulation.

The example of warning is shown in FIG. 3 which is generated when the user enters or attempts to enter the carpool lane when the number of occupants falls short of the minimum required number to drive the carpool lane. The navigation system not only displays the warning message in the text form as shown in FIG. 3 but may also issue the warning by sound alarm or voice message informing about the violation of the traffic regulation. The procedure for detecting the road lane of the current vehicle, lane change for in/out of the carpool lane, and issuing warning will be repeated throughout the driving.

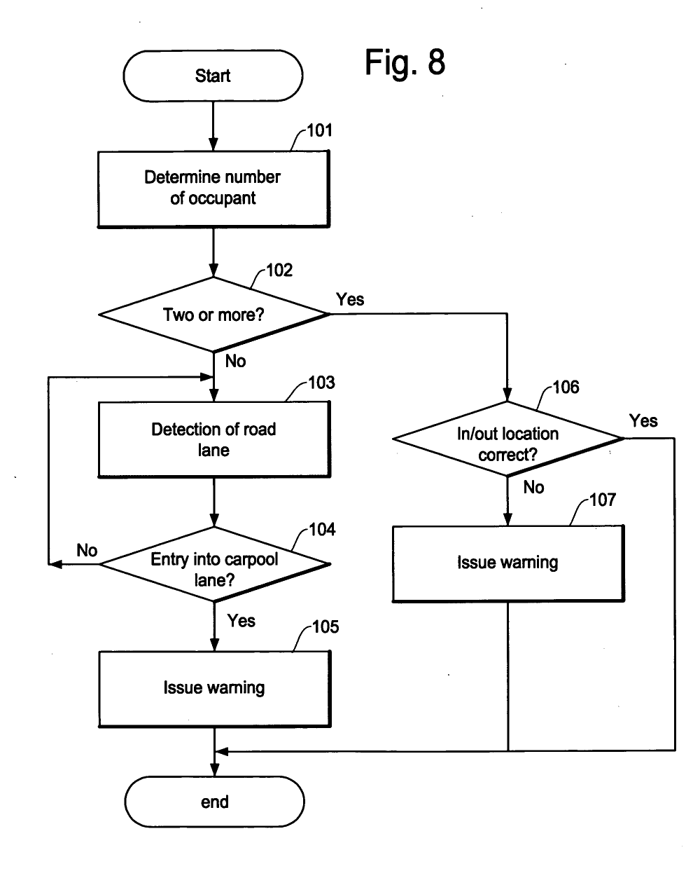

FIG. 9 is a flow chart showing another example of operational process of the present invention for detecting the traffic rule violation concerning the high occupancy vehicle lane and issuing a warning notifying the violation. This process of the present invention further evaluates the type of vehicle because in some states, the traffic regulation allows a specific type of vehicle such as a “hybrid car” or a “fuel cell car” to use the carpool lane even though the number of occupants does not meet the minimum requirement. If the vehicle situation violates the traffic rule as to the carpool lane or about to become the traffic rule violation, the process issues a warning to notify the driver about the violation.

In the example of FIG. 9, the process corresponding to the steps 106 and 107 in FIG. 8 concerning whether a particular location is appropriate for an in/out action with respect to the carpool lane is omitted for simplicity of explanation. As the operation starts, the process will determine the number of occupants in the vehicle in the step 131 with respect to the legal requirement for using the carpool lane. As noted above, the number of occupants may be determined by the user's input, signals from the seat sensors, and/or a number of fastened seat belts as will be described in more detail later. Further, the number of occupants may be determined by processing the data obtained by an image sensor (camera) showing the image of the vehicle inside to distinguish human beings from other objects.

In the next step 132, other requirement prescribed in the traffic regulation regarding the use of the carpool lane is determined. The other requirement relevant to using the carpool lane includes a type of vehicle, type of fuel used, etc. For example, a hybrid vehicle, a vehicle using fuel cells, or a vehicle using ethanol fuel, may also be permitted to drive on the carpool lane even though the number of occupants does not satisfy the requirement.

Then, the process moves to the step 133 to detect the road lane that the vehicle is running thereon and any change of the road lane toward the carpool lane. As noted above, this step of detecting which lane the vehicle is currently running and if there is any lane change is conducted based on the data produced by various sensors especially by the image sensor consisting of camera and radar. Then, the process determines whether the vehicle enters or tries to enter the carpool lane in the step 134.

When the action of entry into the carpool lane is detected, the process moves to the step 135 to determine whether, the condition to use the carpool lane is satisfied. Typically, the number of occupants must be two or more for using the carpool lane, however, in some instances, the minimum number of occupants may be three or more. More over, as noted above, even though the number of occupants in the vehicle is less than two, the vehicle is allowed to use the carpool lane if the vehicle is a hybrid vehicle, a vehicle using fuel cells, or a vehicle using ethanol fuel by the local traffic regulation.

If the condition to use the carpool lane is not satisfied, the navigation system issues the warning in the step 136 to notify the violation of the traffic regulation. The example of warning is shown in FIG. 3 which is generated when the user enters or attempts to enter the carpool lane when the number of occupants or the type of vehicle does not satisfy the requirement. The procedure for detecting the requirement, the road lane of the current vehicle, lane change for in/out of the carpool lane, and issuing warning will be repeated throughout the driving.

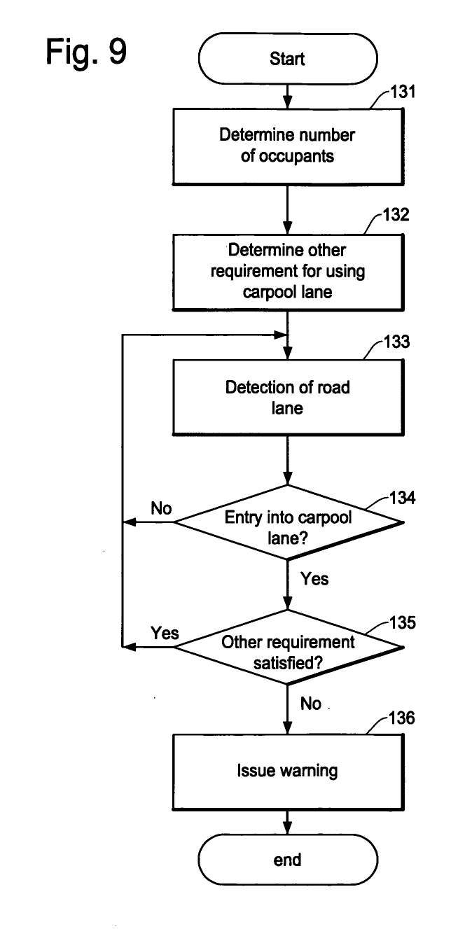

FIG. 10 is a flow chart showing an example of operational steps for determining the number of occupants in the vehicle where the order of conducting the steps is not essential in the present invention. In the step 141, the navigation system checks the data from the seat sensors to detect the number of occupants. In the step 142, the navigation system checks the seat belt condition, which is indicative of the presence of occupants, for example, if the number of fastened seat belt is two, the number of occupants in the vehicle will be detected as two.

In the step 143, image data from the image sensor (camera) showing the inside of the vehicle will be evaluated to detect the number of occupants. The navigation system processes the image data inside of the vehicle to distinguish the human beings from other objects and determines the number of occupants. In the step 144, the navigation system prompts the user to input the number of occupants in the vehicle via touch screen, voice, etc.

Although the steps of determining the number of occupants have been described above in FIG. 10, not all of the steps are required for detecting the number of occupants. If only one step is sufficient to accurately determine the number of occupants, other steps can be omitted from the process. Moreover, as noted above, the order of conducting the steps is not limited to the order shown and described with reference to the flow chart.

FIG. 11 is a schematic diagram showing an example of carpool lane requirements table 171 and current vehicle data table 173. The carpool lane requirements table 171 has the data regarding in what condition the carpool lane can be used based on the traffic regulations. In this example, the required number of occupant must be two or more, the restriction is applicable all day, and there is not vehicle type exception.

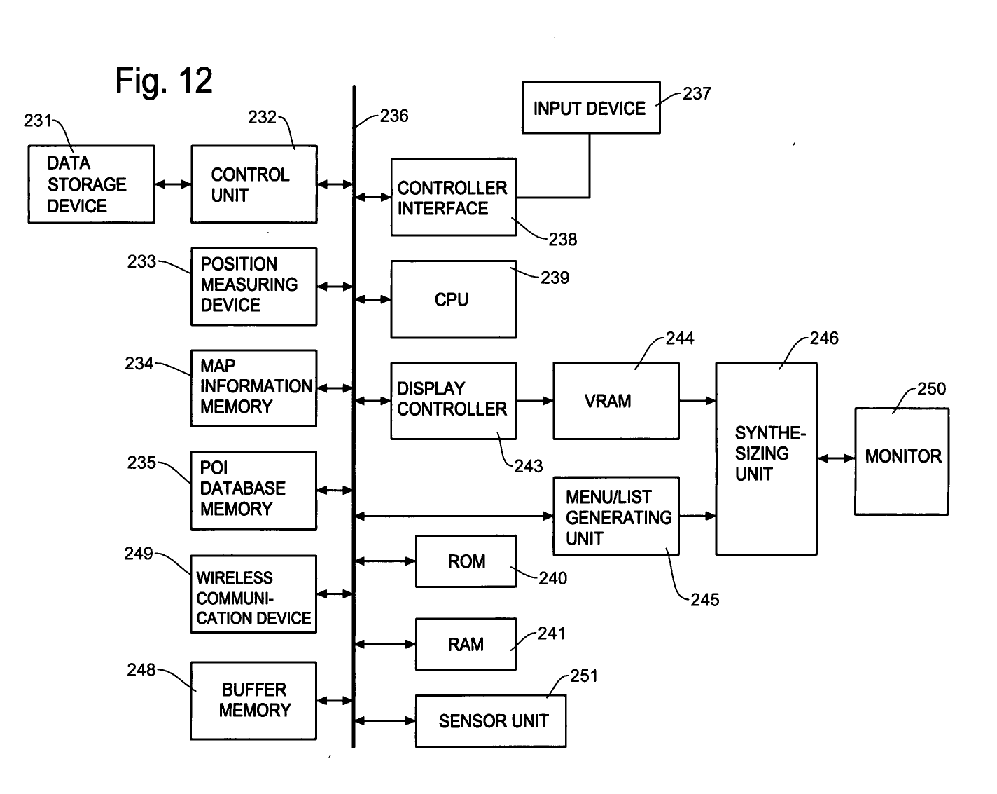

In the current vehicle data table 173, the number of occupant is two which has been detected by the process of FIG. 10, the current time is 8:23 AM, and the vehicle type is a hybrid vehicle. The carpool lane requirements table 171 and the current vehicle data table 173 are compared to determine whether the vehicle is able to drive on the carpool lane. Such data tables 171 and 173 of FIG. 11 may be stored in a memory, such as a RAM 241 in FIG. 12, of the navigation system.

FIG. 12 shows an embodiment of the structure of a vehicle navigation system for implementing the present invention. In the block diagram, the navigation system includes a data storage device 231 such as a hard disc, CD-ROM, DVD, flash memory or other storage means for storing the map data. The navigation system includes a control unit 232 for controlling an operation for reading the information from the data storage device 231, and a position measuring device 233 for measuring the present vehicle position or user position. For example, the position measuring device 233 has a vehicle speed sensor for detecting a moving distance, a gyroscope for detecting a moving direction, a microprocessor for calculating a position, a GPS (global positioning system) receiver, and etc.

The block diagram of FIG. 12 further includes a map information memory 234 for storing the map information which is read from data storage device 231, a database memory 235 for storing database information such as point of interest (POI) information which is read out from the data storage device 231, an input device 237 for executing a menu selection operation, an enlarge/reduce operation, a destination input operation, etc. and a controller interface 238. The input device 237 may be a remote controller, voice recognition device, touch screen, etc.

In FIG. 12, the navigation system further includes a bus 236 for interfacing the above units in the system, a processor (CPU) 239 for controlling an overall operation of the navigation system, a ROM 240 for storing various control programs such as a route search program and a map matching program necessary for navigation control, a RAM 241 for storing a processing result such as a guide route, a display controller 243 for generating map image (a map guide image and an arrow guide image) on the basis of the map information, a VRAM 244 for storing images generated by the display controller 243, a menu/list generating unit 245 for generating menu image/various list images, a synthesizing unit 246, a wireless communication device 249 for wireless communication to retrieve and send data from/to a remote server, a buffer memory 248 for temporally storing data for ease of data processing, a monitor (display) 250, and a sensor unit 51. The monitor (display) 250 may be a touch screen or a multi-touch display that serves as an input device (man-machine interface) as well as a display device.

The sensor unit 251 is a set of sensors used to detect the lane on which the vehicle is driving and lane change. As shown in the diagram in FIGS. 4A and 4B, the sensor unit 251 may include many kinds of sensors, such as video sensor and/or radar sensor. Some sensors, such as GPS sensor or gyroscope may be shared with the position measuring device 233. Those sensors are used to detect entry into the carpool lane as in the step 104 of FIG. 8 and the step 134 of FIG. 9.

The wireless communication device 249 communicates with the outside network, such as internet. By connecting to the outside network, the navigation system may search the up-to-date rules regarding the requirements of carpool lanes for the purpose of determining whether the vehicle is allowed to drive on a particular carpool lane and retrieve the rules from a remote service provider. The monitor 250 displays the warning screen such as shown in FIG. 3 when it has detected carpool lane violation.

The CPU 239 performs, in addition to the traditional navigation function, an overall operation of the present invention described in the flow charts in FIGS. 8-10. A program that performs the steps described in the flow charts in FIGS. 8-10 is stored in ROM 240 or data storage device 231. The data required for the operation of the present invention, such as the data tables 171 and 173 of FIG. 11 may be stored in the RAM 241 or the buffer memory 248.

As has been described above, according to the present invention, the navigation system is able to detect the current situation of a vehicle as to whether there is any actual or anticipated violation of a particular traffic regulation. The present invention is advantageously implemented when such a traffic regulation is directed to the requirements of using a high occupancy vehicle lane (carpool lane). The apparatus of the present invention detects a number of occupants in the vehicle, a position of the vehicle on the road, any change of lane on the road, etc., and determines if there is any violation of the carpool lane requirements. To do this, a plurality of sensors are provided inside and outside of a vehicle to detect the conditions concerning the vehicle with respect to the requirements of the traffic regulation. If the vehicle situation is in the traffic rule violation or about to become the traffic rule violation, the method and apparatus of the present invention issue an alert or warning to notify the driver about the traffic rule violation, thereby avoiding the violation.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method of avoiding violation of carpool lane regulation for a navigation system, comprising the steps of:
evaluating requirements prescribed by local carpool lane regulation for using a carpool lane of a road;
determining a number of occupants of a vehicle with respect to using the carpool lane;
determining whether the number of occupants of the vehicle satisfies the requirements for using the carpool lane;
detecting a current location of the vehicle as to which lane the vehicle is running;
detecting a lane change action for the carpool lane indicating that the vehicle enters the carpool lane or about to enter the carpool lane; and
generating a warning for notifying violation of carpool lane regulation when the lane change action for the carpool lane is detected and the number of occupants fails to satisfy the requirements.

2. A method of avoiding violation of carpool lane regulation as defined in claim 1, wherein said step of evaluating requirements for using the carpool lane includes a step of creating a data table listing the requirements based on map data retrieved from a map database of the navigation system or updated rules searched and retrieved from a remote service provider.

3. A method of avoiding violation of carpool lane regulation as defined in claim 1, wherein said requirements for using the carpool lane include a required number of occupants per vehicle so that only a vehicle having a number of occupants equal to or greater than the required number is allowed to use the carpool lane.

4. A method of avoiding violation of carpool lane regulation as defined in claim 1, wherein said requirements for using the carpool lane include a required number of occupants per vehicle so that only a vehicle having a number of occupants equal to or greater than the required number is allowed to use the carpool lane, and a specific type of vehicle so that only a vehicle of the specified type is allowed to use the carpool lane even though the required number of occupants is not satisfied.

5. A method of avoiding violation of carpool lane regulation as defined in claim 1, further comprising a step of determining whether a particular location on the road for entering the carpool lane from a normal lane or for leaving the carpool lane to enter a normal lane made by the vehicle violates traffic regulation.

6. A method of avoiding violation of carpool lane regulation as defined in claim 5, further comprising a step of generating a warning for notifying violation of the traffic regulation when the particular location on the road for entering the carpool lane or leaving the carpool lane made by the vehicle is illegal.

7. A method of avoiding violation of carpool lane regulation as defined in claim 1, wherein said step of determining the number of occupants of the vehicle includes a step of evaluating signals from seat sensors or seatbelt sensors mounted on the vehicle thereby determining the number of occupants in the vehicle.

8. A method of avoiding violation of carpool lane regulation as defined in claim 7, further comprising a step of evaluating an inner image of the vehicle produced by an image sensor for determining the number of occupants in the vehicle or a step of prompting a user to inputs the number of occupants in the navigation system.

9. A method of avoiding violation of carpool lane regulation as defined in claim 1, wherein said step of detecting the current location of the vehicle as to which lane the vehicle is running includes a step of evaluating image data retrieved from an image sensor in combination with map data of the navigation system which provide data showing a number of lanes, a size of the lane, and a location of the carpool lane.

10. A method of avoiding violation of carpool lane regulation as defined in claim 1, wherein said step of detecting the lane change action for the carpool lane includes a step of evaluating image data retrieved from an image sensor and a signal indicating a degree or rotation of a vehicle driving wheel from a wheel sensor in combination with map data of the navigation system which provide data showing a number of lanes, a size of the lane, and a location of the carpool lane.

11. An apparatus for avoiding violation of carpool lane regulation for a navigation system, comprising:
means for evaluating requirements prescribed by local carpool lane regulation for using a carpool lane of a road;
means for determining a number of occupants of a vehicle with respect to using the carpool lane;
means for determining whether the number of occupants of the vehicle satisfies the requirements for using the carpool lane;
means for detecting a current location of the vehicle as to which lane the vehicle is running;
means for detecting a lane change action for the carpool lane indicating that the vehicle enters the carpool lane or about to enter the carpool lane; and
means for generating a warning for notifying violation of carpool lane regulation when the lane change action for the carpool lane is detected and the number of occupants fails to satisfy the requirements.

12. An apparatus for avoiding violation of carpool lane regulation as defined in claim 11, wherein said means for evaluating requirements for using the carpool lane includes means for creating a data table listing the requirements based on map data retrieved from a map database of the navigation system or updated rules searched and retrieved from a remote service provider.

13. An apparatus for avoiding violation of carpool lane regulation as defined in claim 11, wherein said requirements for using the carpool lane include a required number of occupants per vehicle so that only a vehicle having a number of occupants equal to or greater than the required number is allowed to use the carpool lane.

14. An apparatus for avoiding violation of carpool lane regulation as defined in claim 11, wherein said requirements for using the carpool lane include a required number of occupants per vehicle so that only a vehicle having a number of occupants equal to or greater than the required number is allowed to use the carpool lane, and a specific type of vehicle so that only a vehicle of the specified type is allowed to use the carpool lane even though the required number of occupants is not satisfied.

15. An apparatus for avoiding violation of carpool lane regulation as defined in claim 11, further comprising means for determining whether a particular location on the road for entering the carpool lane from a normal lane or for leaving the carpool lane to enter a normal lane made by the vehicle violates traffic regulation.

16. An apparatus for avoiding violation of carpool lane regulation as defined in claim 15, further comprising means for generating a warning for notifying violation of the traffic regulation when the particular location on the road for entering the carpool lane or leaving the carpool lane made by the vehicle is illegal.

17. An apparatus for avoiding violation of carpool lane regulation as defined in claim 11, wherein said means for determining the number of occupants of the vehicle includes means for evaluating signals from seat sensors or seatbelt sensors mounted on the vehicle thereby determining the number of occupants in the vehicle.

18. An apparatus for avoiding violation of carpool lane regulation as defined in claim 17, further comprising means for evaluating an inner image of the vehicle produced by an image sensor for determining the number of occupants in the vehicle or a step of prompting a user to inputs the number of occupants in the navigation system.

19. An apparatus for avoiding violation of carpool lane regulation as defined in claim 11, wherein said means for detecting the current location of the vehicle as to which lane the vehicle is running includes means for evaluating image data retrieved from an image sensor in combination with map data of the navigation system which provide data showing a number of lanes, a size of the lane, and a location of the carpool lane.

20. An apparatus for avoiding violation of carpool lane regulation as defined in claim 11, wherein said means for detecting the lane change action for the carpool lane includes means for evaluating image data retrieved from an image sensor and a signal indicating a degree or rotation of a vehicle driving wheel from a wheel sensor in combination with map data of the navigation system which provide data showing a number of lanes, a size of the lane, and a location of the carpool lane.
